(19) United States
(12) Patent Application Publication
(10) Pub. No.: US 2016/0142966 A1
(43) Pub. Date: May 19, 2016

(54) METHOD AND SYSTEM FOR UPDATING INTERNET PROTOCOL (IP) REGISTRATION USING MULTIPLE PROTOCOLS

(71) Applicant: VONAGE NETWORK LLC, Holmdel, NJ (US)

(72) Inventor: Mabrouk Aboughanaima, Matawan, NJ (US)

(21) Appl. No.: 14/546,540

(22) Filed: Nov. 18, 2014

(51) Int. Cl. H04W 40/24; H04W 60/00; H04L 29/06; H04W 8/26

(52) U.S. Cl. CPC H04W 40/248; H04W 8/26; H04W 60/00; H04L 65/105; H04W 80/04

(57) ABSTRACT

Apparatus, systems, and methods for updating Internet Protocol (IP) registration on a proxy server, including receiving a device registration message from a first user device in a first protocol, extracting device registration data and network communication address data associated with the first user device from the device registration message, storing an association of the registration data with the network communication address data, and receiving a device registration update message from the first user device in a second protocol.

### BACKGROUND OF THE INVENTION

1. Field of the Invention

Embodiments consistent with the present invention generally relate to a method and system for updating internet protocol (IP) registration using multiple protocols.

2. Description of the Related Art

Modern communications from wireless smartphones to landline user communication devices, such as an analog telephone device, may establish calls with others using internet protocol (IP) communication sessions (e.g., Voice-over IP (VoIP)). For a communications session to be established, a proxy server on an IP network must have access to registration data for user devices on the IP network. Registration data specifying the current location (e.g., IP address) of the user device is used to direct incoming requests to connect to the registered user device. Registration data should be periodically updated to reduce the possibility that the data has become “stale,” i.e., the device is no longer reachable at the registered location. In many current systems, the registration data is sent using a Session Initiation Protocol (SIP) REGISTER message which has a relatively high bandwidth overhead (e.g., 1 kilobyte (kB)). Since many registration messages may be sent for each device over even a modest period of time, the packet overhead cost becomes compounded as more and more user devices are added to the IP network.

Accordingly, there is a need for improved methods and systems for updating internet protocol (IP) registration of devices.

### SUMMARY OF THE INVENTION

Methods and systems for updating Internet Protocol (IP) registration on a proxy server may include receiving a device registration message from a first user device in a first protocol, extracting device registration data and network communication address data associated with the first user device from the device registration message, storing an association of the registration data with the network communication address data, and receiving a device registration update message from the first user device in a second protocol.

In some embodiments, a method for updating Internet Protocol (IP) registration on a proxy server may include generating a device registration message including device registration data and network communication address data of a first user device, sending, from a first user device, the device registration message in a first protocol, generating an update message with a new network communication address of the first user device, and sending the update message from the first user device in a second protocol.

In some embodiments, a system for updating Internet Protocol (IP) registration on a proxy server may include a protocol message receiver configured to receive a device registration message from a first user device a first protocol, and a registration update unit. The registration update unit configured to: extract a device registration data and a network communication address data associated with the first user device from the device registration message, store the registration data and the network communication address data, and receive a device registration update message from the user device in a second protocol.

In some embodiments, an apparatus for updating Internet Protocol (IP) registration on a proxy server may include a processor; and a memory comprising processor-executable instructions including a protocol message module configured to generate a device registration message including device registration data and network communication address data of a first user device, an update module configured to send from a first user device, the device registration message in a first protocol, generate an update message with a new network communication address of the first user device, and send the update message from the first user device in a second protocol.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communication system including a user device in accordance with one or more exemplary embodiments of the invention;

FIG. 2 is a detailed block diagram of a communication system including a user device in accordance with one or more embodiments of the invention;

FIG. 3 is a block diagram of a registration server in an IP telephony network in accordance with one or more embodiments of the invention;

FIG. 4 is a call flow diagram of an exemplary method for updating registration data and completing an IP call using the updated registration data in accordance with one or more embodiments of the invention;

FIG. 5 is a flow diagram of an exemplary method for updating registration data and IP data in accordance with one or more embodiments of the invention;

FIG. 6 is a flow diagram of an exemplary method for updating registration data and IP data in accordance with one or more embodiments of the invention; and

FIG. 7 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention are directed to methods, apparatus, and systems for updating device registration on an IP telephony system with respective Internet Protocol (IP) addresses or location for use in mobile communications. Registration data used to initially register a device with an IP telephony service provider may be sent in a first signaling message using a first protocol (e.g., a Session Initiation Protocol (SIP) message). The stored registration data may be updated using update messages. The update messages have a smaller file size than the first protocol, and thus lower bandwidth usage. The format of the update messages may be different than the initial registration message sent. In addition, the update messages may be sent using a different protocol than the initial registration message. The details and functionality of SIP can be found in the Internet Engineering Task Force (IETF) Request for Comments (RFC) Paper No. 3261 entitled, “SIP: Session Initiation Protocol,” that is herein incorporated in its entirety by reference.

In some embodiments, the registration data may include an IP address, a media access control (MAC) address, and the like. The registration data sent to the IP telephony service provider may be extracted and then stored on a proxy server or registration server on the IP network. In some embodiments, the registration data may also be associated with a user account of a Voice over Internet Protocol (VoIP) service or a telephone number.

VoIP is one non-limiting form of mobile communications, which is utilized to establish and provide voice communications over a data network using the IP. Businesses and individuals implement VoIP by installing the necessary equipment and service (i.e., a “high speed” network or broadband connection) to access a VoIP service provider and activating this telecommunication service. Calls from a VoIP subscriber device to a destination device may be routed via a number of inter-connected networks, such as via the VoIP service provider network, mobile telephone service provider networks, and existing and traditional telecommunications system more commonly referred to as the Public Switched Telephone Network (PSTN) or Plain Old Telephone Service (POTS).

VoIP service providers may provide mobile or desktop VoIP applications (apps) that users can install on their smartphone or other type of mobile or stationary computing devices, or may provide VoIP Telephone/Device Adapters (TA) that can be used with traditional hardwire telephones. Such apps also include over the top (OTT) applications. OTT describes a category of applications where content is delivered without a multiple system operator involved in the control or redistribution of the content.

At least a portion of the call may be transmitted as packets over an IP network, via wireless local area network (WLAN) based on the Institute of Electrical and Electronics Engineers' (IEEE) 802.11x standards for example, rather than over traditional mobile phone mobile communication technology standards (e.g., 2G, 3G, and the like). By transmitting voice as packet data over an IP network, these mobile apps can allow a user to make calls to another OTT client or an off-net destination. They may be used when the user is connected to a base station over the mobile operator's cellular network, over a third-party's WLAN, 802.11x WLAN, 802.13x WLAN, and the like.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the Apple iPhone™, that includes both cellular telephone capabilities and a wireless data transceiver that can establish a wireless data connection to a data network. Such a mobile computing device could run appropriate application software to conduct VOIP telephone calls via a wireless data connection via the terminal adapter. Thus, a mobile computing device, such as an APPLE IPHONE™, a RIM BLACKBERRY or a comparable device running GOOGLE'S ANDROID operating system could be a mobile telephony device. In still other instances, a mobile telephony device may be a device that is not traditionally used as a telephony device, but which includes a wireless data transceiver that can establish a wireless data connection to a data network. Examples of such devices include the APPLE IPOD TOUCH™ and the IPAD™. Such a device may act as a mobile telephony device once it is configured with appropriate application software.

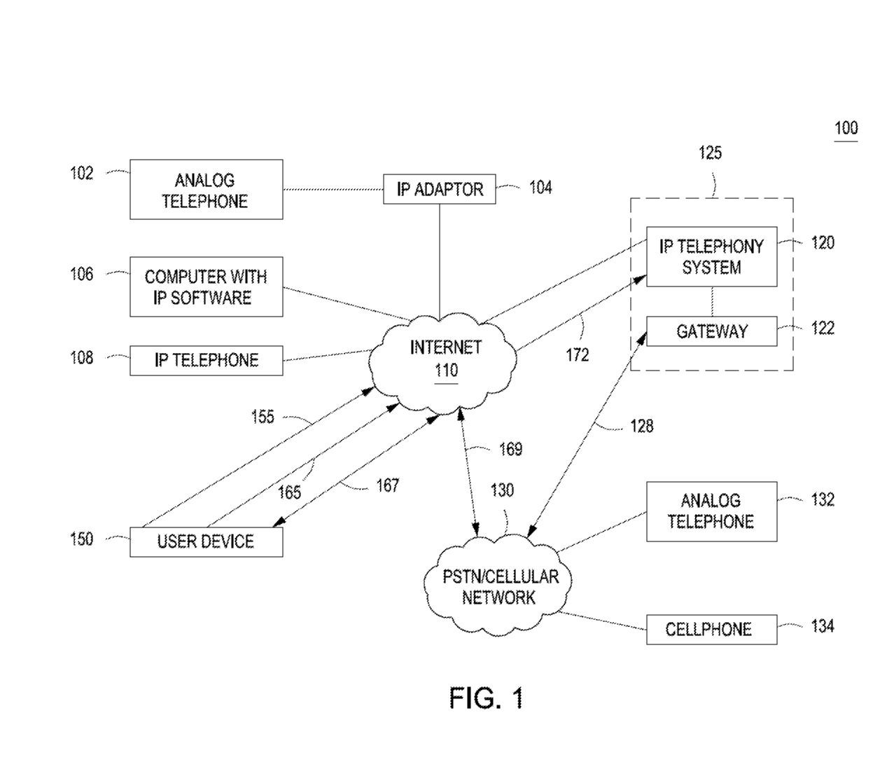

FIG. 1 is a diagram of a communication system 100 including a user device in accordance with one or more exemplary embodiments of the invention. The exemplary communication system 100 includes an Internet 110, an IP telephony system 120, a PSTN/cellular network (hereinafter cellular network) 130, and a user device 150. The user device 150 may be any one of the devices shown in the communications system 100: an analog telephone 102 with IP adapter 104, computer with IP software 106, IP telephone 108, cellphone 134, or another combination of a device with a different text message adapter 138.

The IP telephony system 120 enables connection of telephone calls between its own customers and other parties via data communications that pass over the Internet 110. The IP telephony system 120 and a gateway 122 are part of an IP telephony network 125. The Internet 110 is commonly the Internet, although the IP telephony system 120 may also make use of private data networks. The IP telephony system 120 is connected to the Internet 110. In addition, the IP telephony system 120 is connected to a publicly switched telephone network (PSTN) or cellular network 130 via the gateway 122. The cellular network 130 may also be directly coupled to the Internet 110 through one of its own internal gateways (not shown). Thus, communications may pass back and forth between the IP telephony system 120 and the cellular network 130 through the Internet 110 via a gateway maintained within the cellular network 130.

The gateway 122 allows users and devices that are connected to the cellular network 130 to connect with users and devices that are reachable through the IP telephony system 120, and vice versa (shown as arrow 128). In some instances, the gateway 122 would be a part of the IP telephony system 120. In other instances, the gateway 122 could be maintained by a third party. In other embodiments, the gateway 122 is a wireless gateway that facilitates the communication between the IP telephony system 120 and the cellular network 130.

An analog telephone 102 is communicatively coupled to the Internet 110 via an IP adapter 104. The IP adapter 104 converts analog signals from the analog telephone 102 into data signals that pass over the Internet 110, and vice versa. Analog telephone devices include but are not limited to standard telephones and document imaging devices such as facsimile machines. A configuration using an IP adapter 104 is common where the analog telephone 102 is located in a residence or business. Other configurations are also possible where multiple analog telephones share access through the same IP adapter. In those situations, all analog telephones could share the same telephone number, or multiple communication lines (e.g., additional telephone numbers) may be provisioned by the IP telephony system 120.

In addition, a customer could utilize a soft-phone client running on a computer with IP software 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to an IP adapter 104 that is connected to one or more analog telephones 102.

Users of the communication system 100 are able to access the service from virtually any location where there is an available connection to the Internet 110. Thus, a customer/user could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

A third party using an analog telephone 132 which is connected to the cellular network 130 may call a customer of the IP telephony system 120. In this instance, the call is initially connected from the analog telephone 132 to the PSTN network 130, and then from the PSTN network 130, through the gateway 122 to the IP telephony system 120. The IP telephony system 120 then routes the call to the customer's IP telephony device. A third party using a cellphone 134 could also place a call to an IP telephony system customer, and the connection would be established in a similar manner, although the first link would involve communications between the cellphone 134 and the cellular network 130 to the Internet 110 coupled shown as arrow 169.

In some embodiments, telephony communications are effectuated over a packet-based data network. Signaling that is conducted in the packet-based data network is preferably executed using SIP. However, other messaging protocols besides SIP may be used to connect to the IP telephony system 120. SIP is a popular communication protocol for initiating, managing, and terminating media (e.g., voice, data and video) sessions across packet-based data networks that typically use the Internet Protocol (IP), of which VOIP is an example.

For example, in some embodiments, the initial registration may be a SIP REGISTER message while the update messages may be an Internet Control Message Protocol (ICMP) message. The use of ICMP messages represents a reduction in bandwidth overhead since SIP messages uses at least four network layers, while ICMP may use only two network layers for message transmissions. Specifically, some networking models (e.g., Open Systems Interconnection model (OSI)) characterize and standardize the internal functions of a communication system by partitioning it into network abstraction layers. Each network layer serves the layer above it and is served by the layer below it. In conventional data-communication systems, the communication requirements from the application into data streams in the lower layers is translated. In this translation process, each layer inserts a specific portion of intelligence which is specific to this layer's functionality as well as relational information for navigation between layers. That is, each layer used adds additional bandwidth requirements to the communication messages. Thus, over time, there is a conservation of bandwidth using ICMP instead of SIP or other large bandwidth consuming protocols for update messages since only two network layers for message transmissions are used instead of four or more network layers.

Update messages containing connectivity data are compared to the previously stored connectivity data for a specific user device. For example, an IP address of the user device included in an ICMP update message is compared with an IP address received in the SIP message and stored on the proxy server or registration server. If the IP addresses are different, the stored IP address is replaced with that of the IP address in the ICMP message. The stored IP address on the proxy server is updated such that registration data is maintained with the most current IP address of the user device. Thus, when an IP communications session request is received, the proxy server may coordinate connecting at least two user devices together based on the most recently received connectivity data. In addition to using ICMP for the update message, in some embodiments the update message may be formatted and sent using IPv6 Hop-by-Hop, IP over IP, Internet Group Management Protocol (IGMP), transmission control protocol (TCP), and user datagram protocol (UDP). Other low packet overhead transmission formats and protocols may be used.

In operation, the user device 150 sends an initial registration message in a first protocol (shown as arrow 155), such as SIP, which is used to initially register a device with an IP telephony network 125. The registration message is forwarded, or otherwise communicated (arrow 172) to the IP telephony network 125 to register the user device 150 on the IP telephony system 120. Subsequently, update messages may be sent (arrow 165) in a second protocol, such as ICMP for example, to the IP telephony network 125 via arrow 172 to update the registration data. The IP telephony network 125 stores the registration information included in the update messages and updates the registration information in a proxy server or in a registration server.

In one exemplary operation consistent with the present disclosure, a call originating from the Internet 110 (e.g., from IP telephone 108), requests a connection to the user device 150 via the IP telephony system 120. The IP telephony system 120 retrieves updated connectivity data (e.g., registration data) to determine that a number is mapped to a specific device (e.g., user deice 150). A communication session is then established (shown as arrow 167) with the user device 150 based on the updated registration data. In addition, the user device 150 may be coupled to the Internet 110 through various private broadband networks including the cellular network 130. In alternative embodiments, the second protocol may be IPv6 Hop-by-Hop, IP over IP, transmission control protocol (TCP), Internet Group Management Protocol (IGMP), and user datagram protocol (UDP).

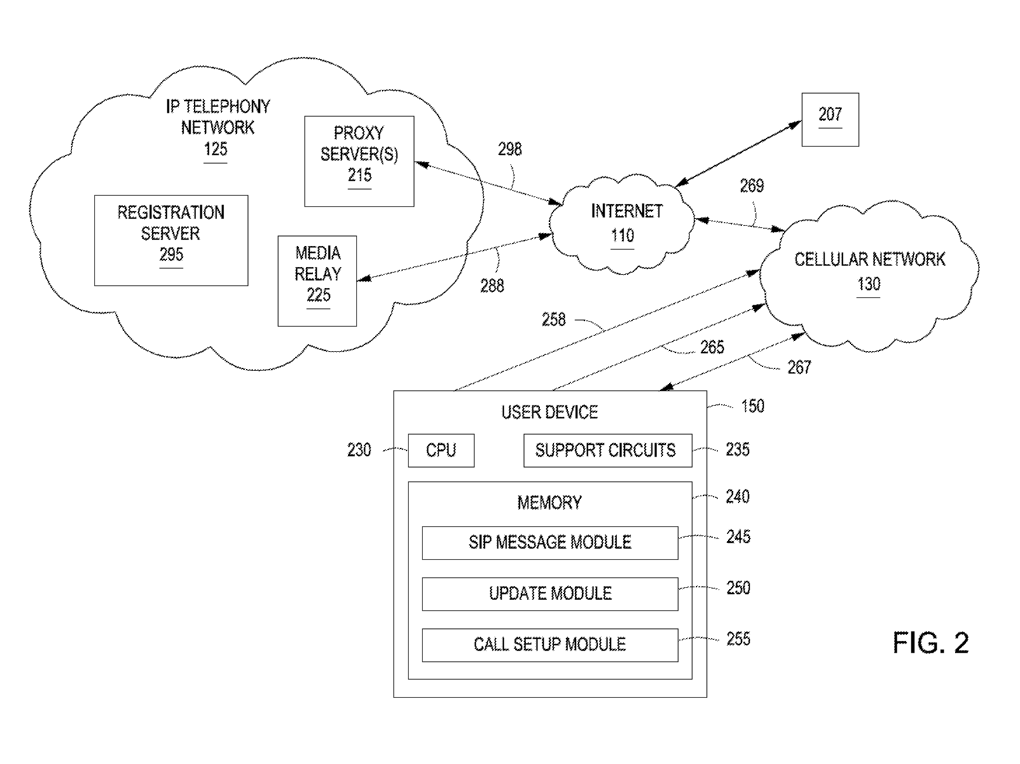

FIG. 2 is a detailed block diagram of the communication 200 system including a user device 150 in accordance with one or more embodiments of the invention. The communication system 200 may be used to communicate among devices and as part of the communication system 100 described above in FIG. 1. As with FIG. 1, the embodiment disclosed in FIG. 2 may also be accomplished with the user device 150 coupled to the Internet 110. However, in the embodiment described below, user device 150 is coupled to the Internet 110 via the cellular network 130 (shown as arrow 169).

The communication system 200 comprises a calling device 207, an IP telephony network 125, a cellular network 130, and the user device 150. The calling device 207 and recipient device 280 may each be any one of the devices shown in the communications system 100: an analog telephone 102 with IP adapter 104, computer with IP software 106, IP telephone 108, or cellphone 134.

The IP telephony network 125 comprises at least one proxy server 215, a media relay 225, and a registration server 295. The registration server 295 coordinates the devices in the IP telephony network 125 to complete a call connection between the calling device 207 and the user device 150. The at least one proxy server 215 receives and processes requests to various electronic communication devices communicatively coupled to the IP telephony network 125 using SIP messages and HTTP messages based on data from the registration server. The registration server 295 receives and stores connectivity data to register the user device 150 such as an IP address, MAC address, user account data, and the like. In some embodiments, the IP telephony network 125 includes a gateway 122 that coordinates with a cellular network 130 (shown as arrow 269) to connect additional user devices to the IP telephony network 125.

The media relay 225 processes audio and/or video communication streams in established communication sessions between user devices. The audio and video communication streams include data packets. The data packets are routed through the IP telephony network 125, the Internet 110, and cellular network 130. The data packets for the communications session may include streaming audio and video transmitted using the real-time transport protocol (RTP). The details and functionality of RTP can be found for example, in the Internet Engineering Task Force (IETF) Request for Comments Paper No. 3550. In alternative embodiments, the media relay 225 is used to communicate between three or more user devices in a conference session across the IP telephony network 125. Further embodiments include peer-to-peer connections that do not rely on the media relay 225.

The user device 150 is configured to send an initial registration message to the registration server 295 in a first protocol (arrow 258) via the cellular network 130. The user device 150 may then send subsequent update messages to the registration server 295 in a second protocol. In some embodiments, the second protocol is one that involves/includes fewer network layers than the first protocol to transmit messages. For example the first protocol may be SIP that may use at least four network layers, while the second protocol may be ICMP that uses two network layers to encapsulate the payload data. Specifically, the network layers in SIP encapsulate the SIP payload in four layers, each with a corresponding header and payload. The SIP layer is encapsulated in a TCP or UDP layer that is then encapsulated in an IP layer and then in an Ethernet layer. However, in ICMP, the data payload maintained in the IP layer is flat, or does not encapsulate further layers such as TCP and UDP packets. The IP payload can thus contain the update data from the user device (e.g., IP address, phone number, account ID, and the like) without additional layer encapsulation for communication. Furthermore, the update message sent in ICMP from the user device advantageously conserves bandwidth overhead since the IP header identifies the message type as ICMP and contains the MAC address of the user device. Thus, the embodiments described herein prevent data from becoming “stale” by using update messages that consume less bandwidth than the initial registration message.

The registration message and update message carry connectivity data (e.g., in the TCP/IP header) to ensure the registration of the user device 150 on the registration server 295 is current using a smaller message size than the first protocol. The user device 150 may be a controller or in other embodiments a custom Application Specific Integrated Circuit (ASIC). The user device 150 comprises a central processing unit (CPU) 230, support circuits 235, and memory 240.

The CPU 230 may be any commercially available processor, microprocessor, microcontroller, and the like. The support circuits 235 comprise well known circuits that provide functionality to the CPU 230 such as clock circuits, cache, power supplies, I/O circuits, display circuits, and the like.

The memory 240 may comprise random access memory, read-only memory, removable disk memory, flash memory, and various combinations thereof. The memory 240 is sometimes referred to a main memory and may in part, be used as cache memory or buffer memory. The memory 240 stores instructions comprising an operating system (if necessary), a SIP message module 245, an update module 250, and a call setup module 255. The operating system coordinates communication among the modules and the CPU 230 that executes the instructions stored in memory 240.

In some embodiments, the SIP message module 245 comprises a set of instructions for aggregating and generating a registration message with registration data such as a MAC address, IP address, port numbers, device identifiers, subscriber identifiers, authentication information, and the like for registration of the user device 150 on the IP telephony network 125. Registration data may be retrieved from the call setup module 255 or from support circuits 235. The SIP message module 245 also coordinates with the call setup module 255 and support circuits 235 to send SIP messages to the registration server 295.

The update module 250 comprises a set of instructions for aggregating and generating a registration update message. In some embodiments, the registration update message is sent using a different protocol than the initial registration message. For example, if the initial registration message is an SIP registration message sent using SIP, the registration update message may be sent using a lower overhead protocol/format, such as ICMP. The registration update message (arrow 265) includes data that may be varied during connectivity to the IP telephony network 125 such as an IP address, IP port number, and the like. The registration update message is then sent to the registration server 295 that updates the association of the MAC address and account data (i.e., that was previously received) with the registration update message data.

The call setup module 255 comprises a set of instructions to complete an IP communication session and includes sending an SIP notification, such as an “SIP OK 200” message to the proxy server 215 (shown as arrow 267). The call setup module 255 may also then connect to the media relay 225 and complete the establishment of a communication session with the calling device 207 and user device 150 (arrow 288). In addition, arrow 267 also represents the communication channel to exchange audio and/or video data for the established communication session.

In operation, the registration server 295 receives the initial registration message from the SIP module 245. Subsequent registration update messages are sent in a different message protocol with lower bandwidth overhead (e.g., ICMP) via the update module 250 to the registration server 295. The update message includes registration data that has changed since the previous registration message or update message, such as a different IP address for the user device 150. When a call is initiated (e.g., from calling device 207 to user device 150), the proxy server 215 and media relay 225 may complete the communication session based on updated registration information retrieved form the registration server 295. In other examples, the calling device 207 (and other devices on the IP telephony network 125) similarly maintains an updated registration with the IP telephony network 125 by sending ICMP update messages.

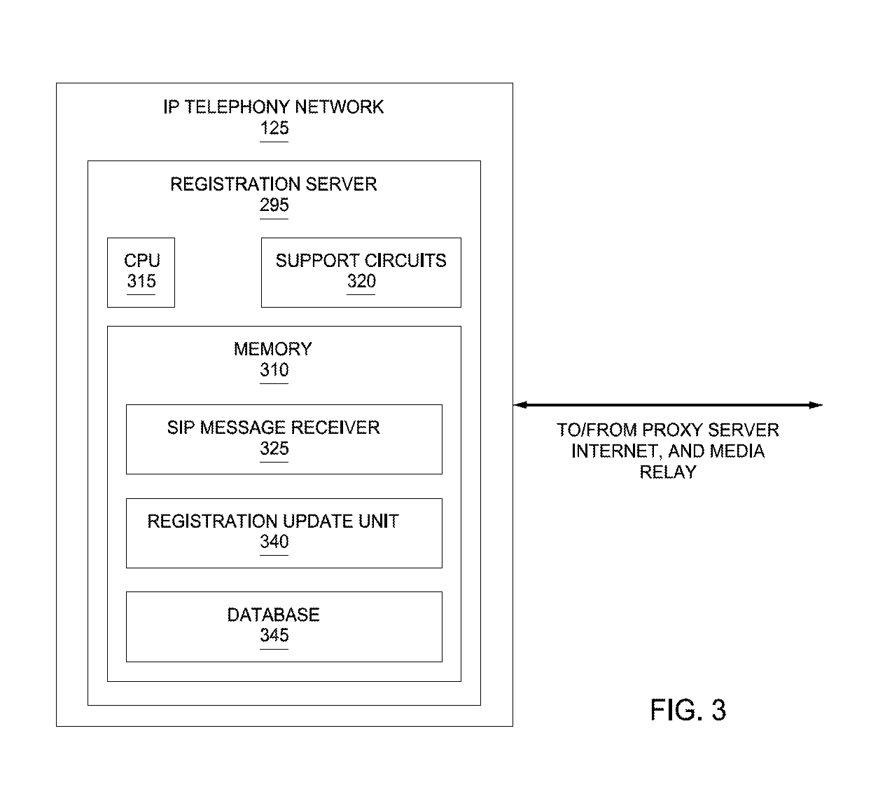

FIG. 3 is a block diagram of a registration server 295 in the IP telephony network in accordance with one or more embodiments of the invention. In some embodiments, the registration server 295 is a unit/module that is part of the proxy server. In other embodiments, the registration server 295 is a separate controller coordinating the communications between the proxy server 215 and media relay 225 in the IP telephony network 125.

The registration server 295 comprises a central processing unit (CPU) 315, support circuits 320, and memory 310. The CPU 315 may be any commercially available processor, microprocessor, microcontroller, and the like. The support circuits 320 comprise well known circuits that provide functionality to the CPU 315 such as clock circuits, cache, power supplies, I/O circuits, and the like.

The memory 310 may comprise random access memory, read-only memory, removable disk memory, flash memory, and various combinations thereof. The memory 310 is sometimes referred to a main memory and may in part, be used as cache memory or buffer memory. The memory 310 stores instructions comprising an operating system (if necessary), a SIP message receiver 325, a registration update unit 340, and a database 345. The operating system coordinates communication among the modules and the CPU 315 that executes the instructions stored in memory 310. The database 345 may store information about the user devices and such as data for a connection to the cellular network 130 and user account data for connecting to the IP telephony network 125.

In some embodiments, the SIP message receiver 325 may be configured to receive and decode registration data from a received SIP message. The payload may include registration data such as a MAC address, and proxy information (e.g., IP address and port number) from a user device 150. The SIP message receiver 325 extracts the payload and stores the registration data for each device in the database 345.

In some embodiments, the registration unit 340 is configured to receive and decode update messages from the user device 150. The registration unit 340 extracts update message data (e.g., IP address of the user device 150) and compares the update message data with the previously received registration data. If the currently received update message data is different than the previously stored data, the registration update unit 340 replaces the stored data in the database 345 with the update information. Thus, the MAC address for the user device 150 will be correctly associated with the most currently received IP address of the user device 150. In some embodiments, the update message data is compared with the previous update message. In either embodiment, the database 345 stores the most current connectivity data associated with a user device 150.

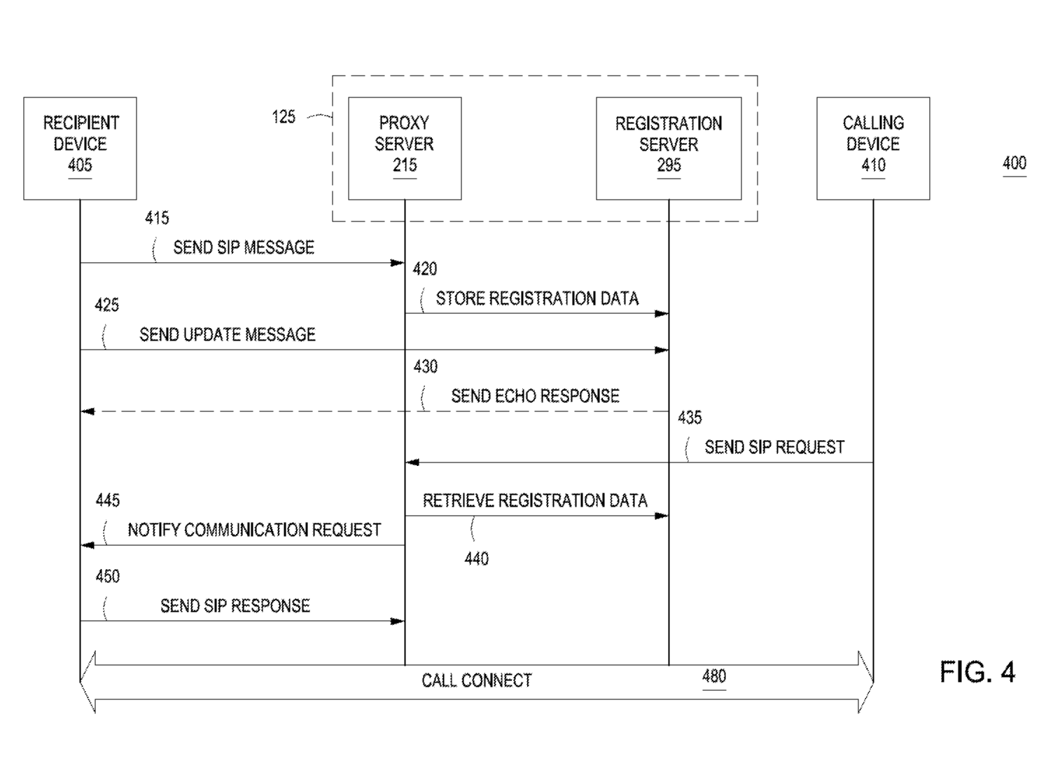

FIG. 4 is a call flow diagram of an exemplary method 400 for updating registration data and completing an IP call using the updated registration data in accordance with one or more embodiments of the invention. The call flow diagram shows the various legs of updating registration information and establishing a communication session based on the updated registration information. Each leg of the call is identified via the network (or component thereof) that it passes through including a recipient device 405, IP telephony network 125, proxy server 215, registration server 295, and calling device 410. The recipient device 405 and calling device 410 may be user device 150 described above in FIGS. 1-3.

As will be described further below, the method 400 includes at least some of the steps from the methods 500 and 600. In 415, the recipient device 405 sends an initial registration message (e.g., SIP message) to the proxy server 215 using a first communication signaling protocol (e.g., SIP). The proxy server 215 then coordinates with the registration server 295 to store the registration data extracted from the registration message and register the recipient device 405 on the IP telephony network 125. In some embodiments, the registration data may include one or more of MAC addresses, IP addresses, user account data and the like that are associated with the recipient device 405.

In 425, an update message is sent in a second, different communication signaling protocol (e.g., ICMP) to the registration server 295. The registration server 295 parses connectivity data and replaces the stored data with any modified registration information included in the update message. For example, if the update message contains a different IP address than the one previously stored on the registration server 295 for the recipient device, the records of the registration server 295 are updated. The registration server 295 may match the SIP message in 415 and update message in 425 to a stored user account (e.g., by account number, MAC address, and the like).

In some embodiments, all information included in the update message is used to replace existing information. In other embodiments, only the modified information included in the update message is used to replace existing information. In some embodiments, updating the records includes associating all user device data for the recipient device 405 with the currently received IP address from the update message.

Optionally, at 430, the registration server 295 may send an echo response message in response to the update message. The echo response message may indicate the latency of receiving the update message, error in the update message, or not receiving an expected update message within a predetermined time period from the previous received update message.

Upon initiating a communication session, an SIP request is sent at 435 from the calling device 410 to the proxy server 215. Other embodiments include multiple proxy servers such as an inbound proxy server and an outbound proxy server. However, for simplification of explanation, the method 400 will be described as operating with the proxy server 215. The proxy server 215 retrieves the most recent registration data in 440 and continues to notify the recipient device 405 in 445 of the communication session request. The notification in 445 may be an SIP message, or other notification message capable of being decoded by the call setup module in the recipient device. The recipient device 405 generates a SIP response message in 450 and sends the SIP response message to the proxy server 215.

The proxy server 215 then coordinates establishing the communication session 480 with the media relay server (not shown) to connect the calling device 410 and recipient device 405. The proxy server 215 negotiates IP addresses and ports such that the media relay server may exchange audio and/or video data between the calling device 410 and recipient device 405.

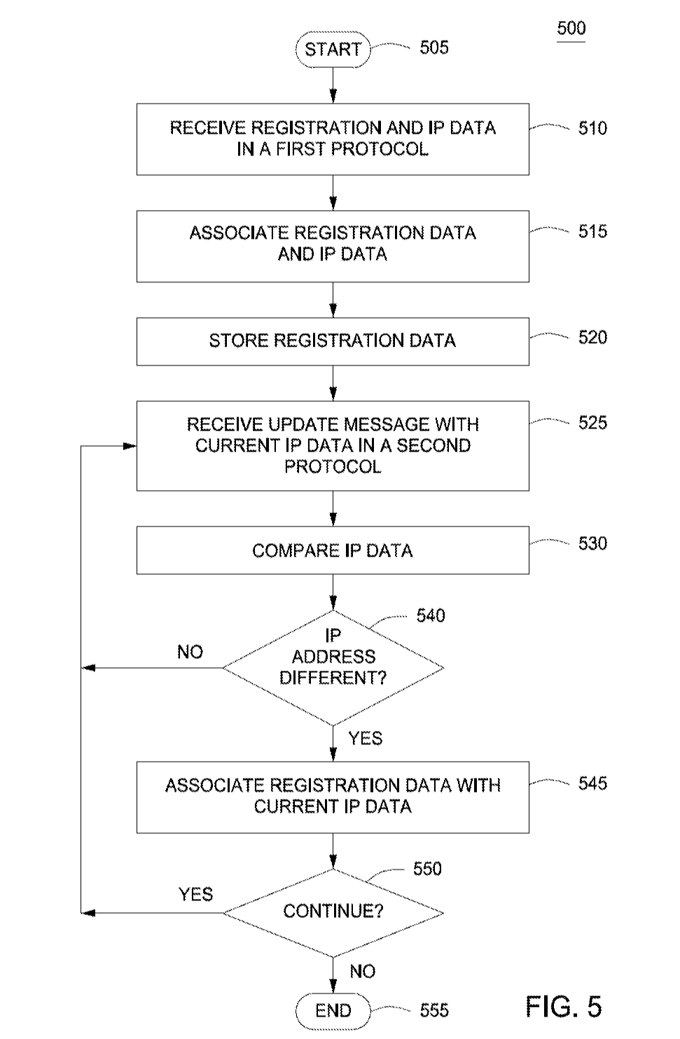

FIG. 5 is a flow diagram of an exemplary method 500 for updating registration data and IP data in accordance with one or more embodiments of the invention. The method 500 is implemented by the IP telephony network 125, user device 150, and registration server 295 described in the above figures above.

The method 500 begins at 505 and continues to 510. At 510, a registration message is received from a user device (e.g., user device 150) in a first protocol (e.g., SIP). The registration message is received by an IP network (e.g., IP telephony network 125). Next at 515, the registration data (e.g., MAC address) and IP data (e.g., IP address, port number, and the like) are stored in association with each other. In some embodiments, the association includes a shared registration record for the user device.

At 520, the registration data and/or user device record is stored in the registration server 295. Next at 525, an update message is received in a second protocol. The second protocol (e.g., ICMP) has fewer network layers than the first protocol (e.g., SIP). By using the second protocol, there is a conservation of bandwidth overhead in sending update messages. The update message includes the current IP address of the user device 150. Alternatively, the update message may include supplemental connectivity data such as phone number, account ID, and data not included in the registration message or previous update message.

At 530, the IP address of user device 150 included in the update message is compared to the IP address previously stored in the registration server 295 for user device 150. At 540, a determination is made as to whether the IP addresses are different. If the IP addresses are the same, the method 500 reverts back to 525. If however, a different IP address is received, the method 500 proceeds to 545.

At 545, the registration data is associated with the current IP address on the registration server 295. Association may include updating the stored shared registration record for the user device 150 on the registration server 295. The method 500 then determines whether to continue the method 500 at 550. If it is determined the method 500 should continue, the method 500 reverts back to 525. If however, a determination is made to end, the method 500 continues to terminate at 555.

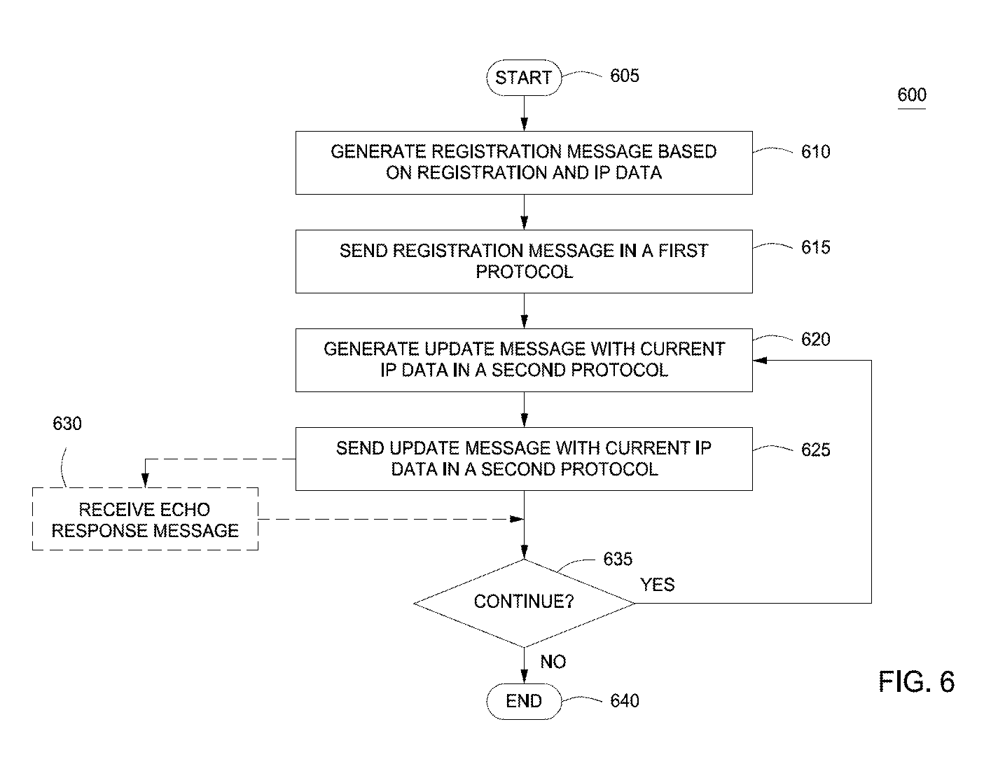

FIG. 6 is a flow diagram of an exemplary method 600 for updating registration data and IP data in accordance with one or more embodiments of the invention. The method 600 is implemented by the IP telephony network 125, user device 150, and registration server 295 described in the above figures above.

The method 600 begins at 605 and continues to 610. At 610, a registration message is generated based on registration data and IP data for the user device 150. The registration message may be generated by the SIP message module 245 using data aggregated from the call setup module 255. At 615, the registration message is sent from the user device 150 to the IP telephony network 125 using a first protocol (e.g., SIP) to register the user device 150 on the IP telephony network 125.

At 620, an update message is generated based on current IP data of the user device 150. The current IP data may be retrieved by the update module 250 from the call setup module 255 or support circuits 235 (e.g., network circuits). At 625, the update message is sent to the registration server 295 using a second protocol (e.g., ICMP) that involves/includes fewer network layers than the first protocol. The update message is processed by the registration server 295 to update the registration records of the user device 150 on the IP telephony network 125.

In some embodiments, the registration server 295 may send an echo response message at 630. The echo response message may confirm receipt of the update message or disclose latency information or error information regarding the update message.

Next at 635, a determination is made as to whether to continue the method 600. In some embodiments, the determination may be based on a predefined instruction to send repeated update messages. If a determination is made to continue the method 600, the method 600 reverts to 620 to generate a subsequent update message. If a determination is made not to continue, the method 600 ends at step 640.

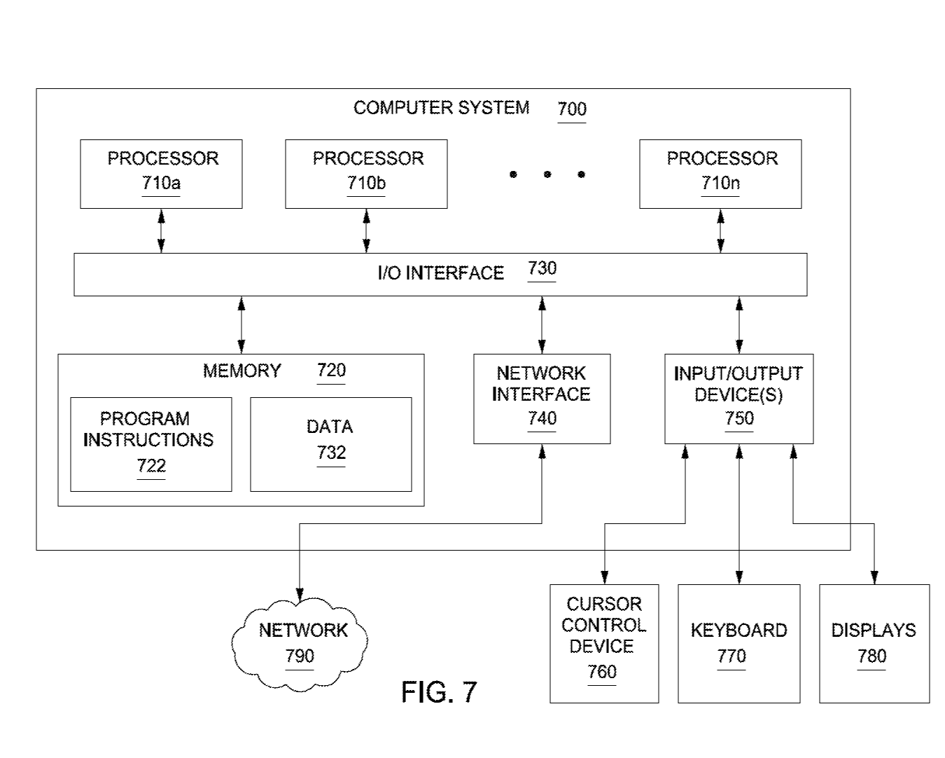

FIG. 7 is a depiction of a computer system 700 that can be utilized in various embodiments of the present invention. The computer system 700 includes substantially similar structure comprising servers or electronic devices in the aforementioned embodiments.

Various embodiments of methods and system authenticating users for completing communication sessions using text messages, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement methods 400, 500, and 600 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 760, such as cursor control device 670, keyboard 770, and display(s) 780. In some embodiments, the keyboard 770 may be a touchscreen input device.

In various embodiments, any of the components may be utilized by the system to authenticate an update message to establish an IP communications session as described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, the processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, cellular networks, 802.11x networks, WLANs, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display devices, keyboards, keypads, cameras, touchpads, touchscreens, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the methods illustrated by the flowchart of FIGS. 5, and 6. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for updating Internet Protocol (IP) registration on a proxy server, comprising:
receiving a device registration message from a first user device in a first protocol;
extracting device registration data and network communication address data associated with the first user device from the device registration message;
storing an association of the registration data with the network communication address data; and
receiving a device registration update message from the first user device in a second protocol.

2. The method of claim 1, further comprising:
determining the network communication address data of the first user device has been modified based on a new network communication address data included in the update message; and
associating the stored registration data with the new network communication address data.

3. The method of claim 1, wherein the network communication address data is an IP address.

4. The method of claim 1, wherein the first protocol comprises more network layers than the second protocol.

5. The method of claim 1, wherein the first protocol is Session Initiation Protocol (SIP).

6. The method of claim 1, wherein the second protocol is Internet Control Message Protocol (ICMP).

7. The method of claim 1, wherein the registration data comprises a media access control (MAC) address.

8. The method of claim 2, further comprising repeatedly receiving subsequent device registration update messages from the first user device in the second protocol and determining for each subsequent device registration update message whether there is a modification in the network communication address data.

9. The method of claim 1, further comprising sending an echo response message confirming receipt of the device registration update message.

10. The method of claim 2, further comprising receiving a request for an IP communications session with the first user device by a second user device and retrieving the registration data and associated new network communication data to establish the IP communications session.

11. A computer-implemented method for updating Internet Protocol (IP) registration on a proxy server, comprising:
generating a device registration message including device registration data and network communication address data of a first user device;
sending, from a first user device, the device registration message in a first protocol;
generating an update message with a new network communication address of the first user device; and
sending the update message from the first user device in a second protocol.

12. The method of claim 11, wherein the first protocol comprises more network layers than the second protocol.

13. The method of claim 11, wherein the first protocol is Session Initiation Protocol (SIP).

14. The method of claim 11, wherein the second protocol is Internet Control Message Protocol (ICMP).

15. The method of claim 9, wherein the registration data comprises a media access control (MAC) address.

16. A system for updating Internet Protocol (IP) registration on a proxy server, comprising:
a protocol message receiver configured to receive a device registration message from a first user device a first protocol;
a registration update unit configured to:
extract a device registration data and a network communication address data associated with the first user device from the device registration message;
store the registration data and the network communication address data; and
receive a device registration update message from the user device in a second protocol.

17. The system of claim 16, wherein the registration update unit is further configured to:
determine the network communication address data of the first user device has been modified based on a new network communication address data included in the update message; and
associate the stored registration data with the new network communication address data.

18. The system of claim 16, wherein the network communication address data is an IP address.

19. The system of claim 16, wherein the first protocol comprises more network layers than the second protocol.

20. The system of claim 16, wherein the first protocol is Session Initiation Protocol (SIP) and the second protocol is Internet Control Message Protocol (ICMP).

21. An apparatus for updating Internet Protocol (IP) registration on a proxy server, comprising:
a processor; and
a memory comprising processor-executable instructions including:
a protocol message module configured to generate a device registration message including device registration data and network communication address data of a first user device; and
an update module configured to send from a first user device, the device registration message in a first protocol, generate an update message with a new network communication address of the first user device, and send the update message from the first user device in a second protocol.

22. The apparatus of claim 21, wherein the network communication address data is an IP address.

23. The apparatus of claim 21, wherein the first protocol comprises more network layers than the second protocol.

24. The apparatus of claim 21, wherein the first protocol is Session Initiation Protocol (SIP) and the second protocol is Internet Control Message Protocol (ICMP).
